(19) United States
(12) Patent Application Publication
(10) Pub. No.: US 2011/0264250 A1
(43) Pub. Date: Oct. 27, 2011

(54) SUBSTRATE PROCESSING SYSTEM, SUBSTRATE PROCESSING METHOD AND STORAGE MEDIUM STORING PROGRAM

(75) Inventors: Masaru Nishimura, Miyagi (JP); Hiroyuki Takano, Miyagi (JP); Souichi Nishijima, Miyagi (JP)

(73) Assignee: TOKYO ELECTRON LIMITED, Minato-ku, Tokyo (JP)

(21) Appl. No.: 13/139,569

(22) PCT Filed: Dec. 14, 2009
(86) PCT No.: PCT/JP2009/070815

§ 371 Date: Jul. 15, 2011

(30) Foreign Application Priority Data
Dec. 15, 2008 (JP) 2008-318541

(51) Int. Cl. G05B 19/418; F16K 99/00

(52) U.S. Cl. 700/96; 251/356

(57) ABSTRACT

A substrate processing system includes a controller that outputs a control signal for controlling a substrate processing apparatus; and a software interlock component that outputs an interlock signal if a predetermined interlock condition is satisfied. In the substrate processing apparatus, a multiple number of devices of the same kind are provided and each device is selected to be either an interlocked state or a non-interlocked state with other devices. The software interlock component outputs an interlock signal to any one of the multiple number of devices of the same kind if it is determined that the multiple number of devices satisfy the predetermined interlock condition. If any one of the multiple number of devices of the same kind receives the interlock signal, the multiple number of devices are interlocked according to an instruction of the interlock signal regardless of an interlocked state or a non-interlocked state of the devices.

### TECHNICAL FIELD

The present invention relates to a substrate processing system including an interlock component, a substrate processing method and a storage medium storing a program for implementing a function of the substrate processing system.

### BACKGROUND ART

Recently, a substrate processing system having a multiple number of cluster substrate processing apparatuses has been provided in a semiconductor manufacturing factory. Each substrate processing apparatus is connected with a controller via a network. The controller outputs a control signal to the substrate processing apparatus at a predetermined time according to a recipe. The substrate processing apparatus controls, for example, opening/closing of various valves and an opening degree of an APC (Automatic Pressure Control) valve or a pump in response to the control signal, so that a process such as an etching process or a film forming process is performed onto a substrate.

When the substrate processing apparatus is in an abnormal state, even if devices within the substrate processing apparatus are controlled in response to the control signal, an inside of the substrate processing apparatus cannot be maintained in a desired atmosphere, a desired process cannot be performed onto the substrate, or the substrate being transferred may collide with other devices. Thus, conventionally, an interlock component (device) for preventing malfunction of the devices has been employed. The interlock component is configured to receive a signal from a sensor that detects a status of each device within the substrate processing apparatus, determine that the device is in an abnormal state when the received signal satisfies a predetermined interlock condition, and output an interlock signal for preventing malfunction of the device. The operation of the device may stop in response to an instruction of the interlock signal.

In case of a hardware interlock device as one of interlock devices having the above-described function, the interlock condition is stored in a circuit (hardware), and, thus, a circuit design is difficult. In particular, as a substrate processing system has recently been varied and complicated, a design burden has further increased and it has become difficult to change an interlock circuit design or make an addition thereto.

Thus, there has been developed a software interlock component in which the interlock condition that has been conventionally implemented by a hardware circuit is implemented by a program (software) (see, for example, Patent Document 1). By way of example, a safety PLC (Programmable Logic Controller) is developed as a safety-certified software interlock component.
Patent Document 1: Japanese Patent Laid-open Publication No. H5-120006

### DISCLOSURE OF THE INVENTION

### Problems to be Solved by the Invention

However, when a multiple number of devices of the same kind are provided in a substrate processing apparatus, the multiple number of devices may be selected to be an interlocked state or a non-interlocked state. In this case, the multiple number of devices selected to be in an interlocked state may perform interlocked operations in response to a control signal (cluster control). Meanwhile, other devices selected to be in a non-interlocked state may maintain the status quo even if the control signal is received.

By way of example, assuming that a multiple number of APC valves connected with a pump are provided in a single substrate processing apparatus. Here, when all the APC valves are closed, if an operator wants to sufficiently evacuate an inside of the substrate processing apparatus but does not want to evacuate a foreside thereof, the operator may set the APC valves on the inside of the apparatus to be in an interlocked state and the APC valves on the foreside of the apparatus to be in a non-interlocked state. In such a case, if a control signal to open the APC valves is output, the interlocked APC valves on the inside of the apparatus are open accordingly. On the contrary, the non-interlocked APC valves on the foreside of the apparatus are maintained as closed. By selecting the interlocked state or the non-interlocked state as described above, even if the multiple number of devices of the same kind are provided, the respective devices can perform a difference operation each other.

The cluster control by the control signal may be performed in a similar manner in response to an interlock signal. That is, the multiple number of devices selected to be in the interlocked state may be cluster-controlled in response to the interlock signal output from the software interlock component (device), whereas the devices selected to be in the non-interlocked state do not respond to the interlock signal and maintain the status quo. Thus, even if an emergency occurs to avoid an accident in response to an instruction from the software interlock component, the devices in the non-interlocked state cannot be controlled in response to the interlock signal. If an interlock function is not imperfect, a safety action cannot be taken promptly, so that the system may be in an unsafe state. By way of example, if the system is in a shutdown state or the system is operated in an unstable state, the inside of the substrate processing apparatus cannot be maintained in a desired atmosphere. Therefore, a processed substrate is not valuable as a product and a throughput becomes decreased and productivity of the system also becomes decreased. Further, a system manager may feel pressured.

Accordingly, the present invention provides a substrate processing system capable of controlling devices of the same kind under a cluster control in response to an interlock signal regardless of an interlocked state or a non-interlocked state of the devices when a software interlock component transmits a signal to notify abnormality, a substrate processing method and a storage medium storing a program for implementing a function of the substrate processing system.

### Means for Solving the Problems

In order to solve the above-described problems, in accordance with one aspect of the present invention, there is provided a substrate processing system including a controller that outputs a control signal for controlling a substrate processing apparatus; and a software interlock component that outputs an interlock signal if a predetermined interlock condition is satisfied. In the substrate processing system, a multiple number of devices of the same kind are provided in the substrate processing apparatus, and each device is selected to be either an interlocked state or a non-interlocked state with other devices. The software interlock component is configured to output an interlock signal to any one of the multiple number of devices of the same kind if it is determined that the multiple number of devices of the same kind satisfy the predetermined interlock condition. If any one of the multiple number of devices of the same kind receives the interlock signal, the multiple number of devices of the same kind are interlocked according to an instruction of the interlock signal regardless of an interlocked state or a non-interlocked state of the devices.

With this configuration, sensors attached to the multiple number of devices of the same kind may detect abnormality, and if it is determined that the multiple number of devices of the same kind satisfy the predetermined interlock condition, the interlock signal may be output. In this case, the multiple number of devices may be interlocked according to the instruction of the interlock signal regardless of an interlocked state or a non-interlocked state of the devices. Accordingly, even if any one of the devices of the same kind is in the non-interlocked state, all the devices may be forced to perform interlocked operations according to the instruction of the interlock signal. Consequently, all the devices can perform an interlock function and a safety action can be taken promptly. Thus, it is possible to avoid a shutdown of a system and stabilize an operation status, so that a throughput can be improved and productivity of the system can be increased. Further, a maintenance burden on a system manager may be reduced.

While the interlock signal that satisfies the predetermined interlock condition is output, the multiple number of devices of the same kind may invalidate the control signal output from the controller and maintain interlocked operations according to the instruction of the interlock signal.

The substrate processing system may further include a display that displays a status in which the devices in the non-interlocked state among the multiple number of devices of the same kind perform interlocked operations with the devices in the interlocked state while the interlock signal that satisfies the predetermined interlock condition is output.

If the interlock signal that satisfies the predetermined interlock condition is cancelled, the multiple number of devices of the same kind may validate the control signal output from the controller and the devices in the interlocked state may perform interlocked operations according to an instruction of the control signal.

The display may display whether the multiple number of devices of the same kind are in an interlocked state or a non-interlocked state if the interlock signal that satisfies the predetermined interlock condition is cancelled.

By way of example, the multiple number of devices of the same kind may be a multiple number of automatic pressure controllers provided in the substrate processing apparatus.

Alternatively, the multiple number of devices of the same kind may be, by way of example, shut-off valves and pressure control valves provided independently from each other in the substrate processing apparatus. Here, at least one of the shut-off valves and the pressure control valves may perform an interlocked operation according to the instruction of the interlock signal if it is determined that the predetermined interlock condition is satisfied regardless of an interlocked state or a non-interlocked state of the valves.

Further, in order to solve the above-described problems, in accordance with another aspect of the present invention, there is provided a substrate processing method using a substrate processing system including a controller that outputs a control signal for controlling a substrate processing apparatus; and a software interlock component that outputs an interlock signal if a predetermined interlock condition is satisfied. The substrate processing method includes selecting each device, among a multiple number of devices of the same kind provided in the substrate processing apparatus, to be either an interlocked state or a non-interlocked state with other devices; outputting, by the software interlock component, an interlock signal if the software interlock component determines that the multiple number of devices of the same kind satisfy the predetermined interlock condition; and if any one of the multiple number of devices of the same kind receives the interlock signal, controlling the multiple number of devices of the same kind to be interlocked according to an instruction of the interlock signal regardless of an interlocked state or a non-interlocked state of the devices.

Moreover, in order to solve the above-described problems, in accordance with still another aspect of the present invention, there is provided a storage medium having stored thereon a computer-executable program for implementing, a function of a substrate processing system including a controller that outputs a control signal for controlling a substrate processing apparatus; and a software interlock component that outputs an interlock signal if a predetermined interlock condition is satisfied. Here, the program causes a computer to perform operations including: selecting each device, among a multiple number of devices of the same kind provided in the substrate processing apparatus, to be either an interlocked state or a non-interlocked state with other devices; outputting, by the software interlock component, an interlock signal if the software interlock component determines that the multiple number of devices of the same kind satisfy the predetermined interlock condition; and if any one of the multiple number of devices of the same kind receives the interlock signal, controlling the multiple number of devices of the same kind to be interlocked according to an instruction of the interlock signal regardless of an interlocked state or a non-interlocked state of the devices.

In order to solve the above-described problems, in accordance with still another aspect of the present invention, there is provided at least one valve having a shut-off function and provided in a substrate processing apparatus. Each valve is configured to have an interlocked mode or a non-interlocked mode and each valve is interlocked according to an instruction of the interlock signal regardless of an interlocked state or a non-interlocked state of the valve if it is determined that a predetermined interlock condition is satisfied.

The at least one valve may be plural in number and provided in the substrate processing apparatus.

The valves may be arranged in parallel with each other.

The valve may be positioned on an evacuation side of the substrate processing apparatus.

### Effect of the Invention

As described above, in accordance with the present invention, if a software interlock component (device) transmits a signal to notify abnormality, it is possible to control a multiple number of devices of the same kind in response to an interlock signal regardless of an interlocked state or a non-interlocked state of the devices.

### BRIEF DESCRIPTION OF THE DRAWINGS

FIG. 1 is a schematic configuration view of a substrate processing system in accordance with a first embodiment and a second embodiment of the present invention;

FIG. 2 is a longitudinal cross sectional view of a process module (PM3) in accordance with the first embodiment;

FIG. 3 is a perspective view of a process module (PM4) in accordance with the first embodiment;

FIG. 4 is a diagram for explaining a relationship between an interlock signal and an operation of a multiple number of cluster devices in accordance with the first embodiment;

FIG. 5 shows an example of an interlock condition table;

FIG. 6 is a diagram for explaining a relationship between an interlock signal in a normal state and an operation of a multiple number of cluster devices in accordance with the first embodiment;

FIG. 7 is a diagram for explaining a relationship between an interlock signal in an abnormal state and an operation of a multiple number of cluster devices in accordance with the first embodiment and a conventional method;

FIG. 8 is a diagram for explaining a relationship between an interlock signal in an abnormal state and an operation of a multiple number of cluster devices in accordance with the first embodiment and the conventional method;

FIG. 9 is a flowchart of a serial signal/interlock signal process in accordance with the first embodiment;

FIG. 10 shows a maintenance screen under interlock control in accordance with the first embodiment;

FIG. 11 shows a maintenance screen under interlock control and non-interlock control in accordance with the first embodiment;

FIG. 12 shows a maintenance screen during a generation of interlock in accordance with the first embodiment;

FIG. 13 shows a maintenance screen during a generation of interlock in accordance with the conventional method;

FIG. 14 is a schematic diagram of a process module when a shut-off valve and a pressure control valve are integrated (in case of APC valves) in accordance with the first embodiment;

FIG. 15 shows an example of a signal input when a shut-off valve and a pressure control valve are integrated (in case of APC valves) in accordance with the first embodiment;

FIG. 16 shows another example of a signal input when a shut-off valve and a pressure control valve are integrated (in case of APC valves) in accordance with the first embodiment;

FIG. 17 is a schematic diagram of a process module when a shut-off valve and a pressure control valve are provided independently from each other in accordance with the second embodiment;

FIG. 18 shows an example of a signal input when a shut-off valve and a pressure control valve are provided independently from each other in accordance with the second embodiment;

FIG. 19 shows another example of a signal input when a shut-off valve and a pressure control valve are provided independently from each other in accordance with the second embodiment;

FIG. 20 shows an operation example in case of a large flow rate in accordance with the second embodiment;

FIG. 21 shows an operation example in case of a middle flow rate in accordance with the second embodiment;

FIG. 22 shows an operation example in case of a middle flow rate in accordance with the second embodiment;

FIG. 23 shows an operation example in case of a middle flow rate in accordance with the second embodiment;

FIG. 24 shows an operation example in case of a small flow rate in accordance with the second embodiment;

FIG. 25 shows an operation example in case of a small flow rate in accordance with the second embodiment;

FIG. 26 shows an operation example in case of a small flow rate in accordance with the second embodiment;

FIG. 27 shows an operation example in case of a small flow rate in accordance with the first embodiment;

FIG. 28 shows an operation example in case of a small flow rate in accordance with the first embodiment; and

FIG. 29 shows an operation example in case of a small flow rate in accordance with the first embodiment.

### BEST MODE FOR CARRYING OUT THE INVENTION

Hereinafter, embodiments of the present invention will be described in detail with reference to the accompanying drawings. Through the present specification and drawings, parts having substantially the same function and configuration will be assigned same reference numerals, and redundant description will be omitted.

### First Embodiment

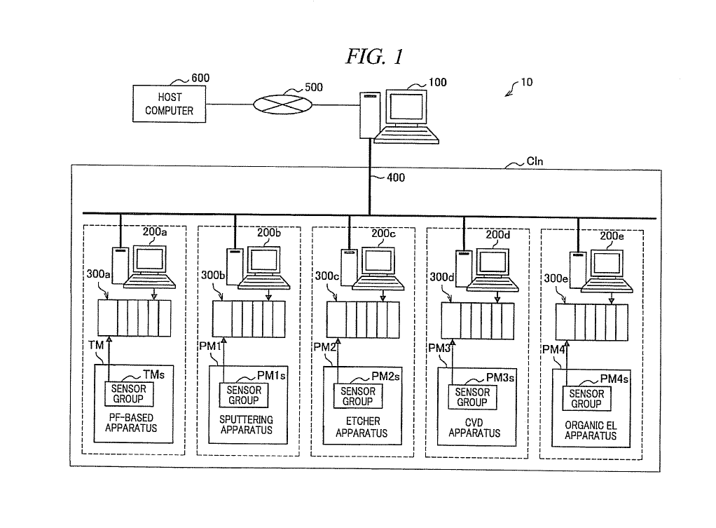

A substrate processing system in accordance with a first embodiment of the present invention will be explained with reference to FIG. 1. FIG. 1 is a schematic configuration view of the substrate processing system in accordance with the first embodiment.

[Substrate Processing System]

A substrate processing system 10 may include a main PC (Personal Computer) 100, sub PCs 200a to 200e, safety PLCs (Programmable Logic Controller) 300a to 300e, a transfer module TM, and process modules PM1 to PM4. These devices may be connected with each other via a network 400 such as Ethernet (registered trademark). Further, the main PC 100 may be connected with a host computer 600 via a LAN (Local Area Network) 500.

The sub PCs 200a to 200e may be respectively positioned in the vicinity of the transfer module TM and the process modules PM1 to PM4 within a clean room Cln. The main PC 100 may be positioned outside the clean room Cln. The main PC 100 may remotely control each of the transfer module TM and the process modules PM1 to PM4 by receiving/transmitting a control signal from/to the sub PCs 200a to 200e. To be specific, the main PC 100 may transmit a control signal to transfer a substrate by the transfer module TM and a control signal to perform a microprocessing onto the substrate in the process modules PM1 to PM4.

A substrate process performed in each process module PM may include a sputtering process performed in the process module PM1, an etching process performed in the process module PM2, a CVD (Chemical Vapor Deposition) process performed in the process module PM3, and a six-layer consecutive organic EL film vapor deposition process performed in the process module PM4. A number or an arrangement of the process modules PM and the transfer module TM are not limited to the above-described example and can be determined in any other way. Further, the transfer module TM and the process modules PM1 to PM4 are examples of a substrate processing apparatus that processes the substrate. The main PC 100 is an example of a controller that outputs a control signal to control the substrate processing apparatus. Alternatively, it is also possible to call all the main PC 100 and the sub PCs 200a to 200e as a controller.

The transfer module TM and the process modules PM1 to PM4 may be respectively provided with sensor groups TMs, PM1s to PM4s, and the respective sensor groups TMs, PM1s to PM4s may detect a status of each device provided in each module. Detection values of the sensor groups TMs, PM1s to PM4s may be input to the safety PLCs 300a to 300e, respectively. A safety PLC 300 may correspond to a safety-certified software interlock component (device) implemented by programming an interlock function of a hardware interlock device (safety circuit) to control the interlock function.

The safety PLC 300 may receive detection signals from the sensor groups and if the detection signals of the sensor groups satisfy a predetermined interlock condition, the safety PLC 300 may output an interlock signal to notify abnormality. Thus, operations of relevant devices within the transfer module TM and the process modules PM1 to PM4 may stop temporarily. As a result, the devices within the transfer module TM and the process modules PM1 to PM4 can be protected from a danger that, for example, an unsuitable gas is supplied or the substrate may collide with other devices, and it may become easy for an operator in a factory to carry out maintenance. The host computer 600 may manage the entire substrate processing system 10 as well as data management by receiving/transmitting data from/to the main PC 100.

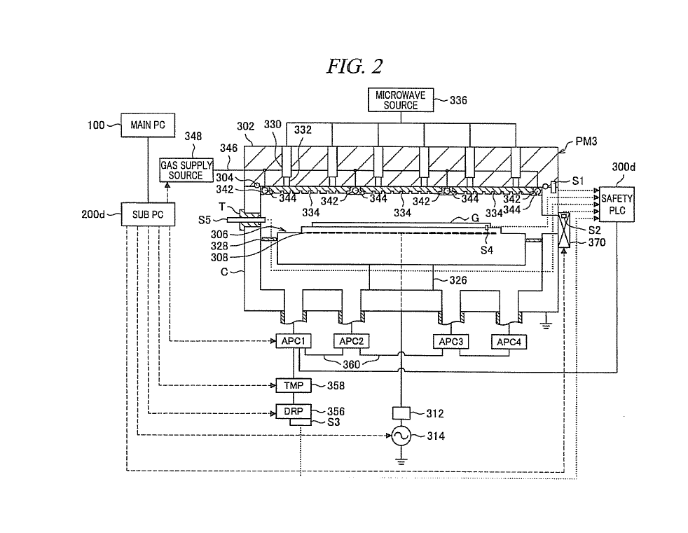

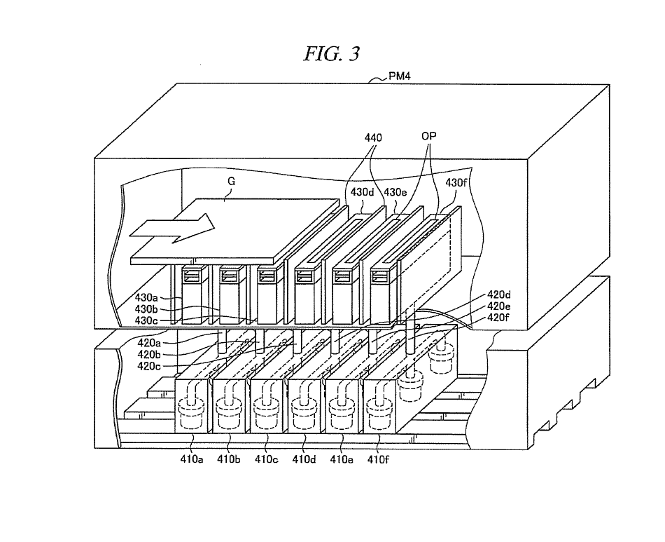

Hereinafter, as examples of internal configurations of the process modules PM1 to PM4, an internal configuration of each of the process module PM3 for performing a CVD process and the process module PM4 for performing a six-layer consecutive organic EL vapor deposition process will be explained with reference to FIGS. 2 and 3. FIG. 2 is a longitudinal cross sectional view of a microwave plasma processing apparatus (CVD apparatus) provided in the process module PM3, and FIG. 3 is a perspective view schematically showing main parts of a six-layer consecutive organic EL vapor deposition apparatus provided in the process module PM4.

[Internal Configuration of Process Module PM3]

A microwave plasma processing apparatus of the process module PM3 may include a cube-shaped processing chamber C having a bottom and an opened ceiling. A lid 302 may be secured at the ceiling of the processing chamber C. An O-ring 304 may be provided at a contact surface between the processing chamber C and the lid 302 so as to maintain airtightness in a processing chamber. The processing chamber C and the lid 302 may be made of metal such as aluminum and electrically grounded.

A susceptor 306 for mounting thereon a glass substrate (hereinafter, referred to as “substrate”) G may be provided within the processing chamber C. The susceptor 306 may be made of, for example, aluminum nitride and a power supply member 308 may be installed therein. The power supply member 308 may be connected with a high frequency power supply 314 via a matching unit 312. The high frequency power supply 314 may be grounded. The power supply member 308 may be configured to apply predetermined bias voltage to an inside of the processing chamber C with high frequency power output from the high frequency power supply 314. The susceptor 306 may be supported on a cylindrical body 326. A baffle plate 328 is provided around the susceptor 306 in order to control a flow of a gas in the processing chamber to be in a desired state.

The lid 302 may be provided with six waveguides 330, a slot antenna 332 and a multiple sheet of dielectric members 334. Each of the waveguides 330 may have a rectangular cross section and the waveguides 330 may be arranged in parallel with each other within the lid 302.

The slot antenna 332 may be positioned under the lid 302 as a single part with the lid 302. The slot antenna 332 may be made of non-magnetic metal such as aluminum. The slot antenna 332 may have slots (openings) each of which corresponds to a bottom of each waveguide 330. Each waveguide 330 and each slot may be filled with a dielectric material such as fluorine resin, alumina (Al₂O₃) and quartz.

With the aforementioned configuration, a microwave output from a microwave source 336 may propagate each waveguide 330 and pass through the slots of the slot antenna 332 and each dielectric member 334 to be incident into the processing chamber C.

At a bottom surface of the slot antenna 332, the multiple sheet of dielectric members 334 may be supported by beams 342. The beams 342 may be made of non-magnetic material such as aluminum. A gas inlet line 344 may be formed in the beam 342. The gas inlet line 344 may be connected with a gas supply source 348 via a gas line 346. A gas may be supplied from the gas supply source 348 through the gas line 346 and introduced into the processing chamber through the gas inlet line 344.

In the present embodiment, four APC valves may be provided in a single substrate processing apparatus. An APC valve 1, an APC valve 2, an APC valve 3 and an APC valve 4 (hereinafter, simply referred to as APC1, APC2, APC3 and APC4) may automatically adjust a pressure within the processing chamber by adjusting an opening degree of each valve. A dry pump (DRP) 356 may perform a rough evacuation of an inside of the processing chamber via each APC, and a turbo molecular pump (TMP) 358 may perform a vacuum evacuation of the inside of the processing chamber. Thus, the inside of the processing chamber may be maintained at a predetermined vacuum level.

Each of the APC1, APC2, APC3, and APC4 may be connected with its adjacent one via a network 360 such as Ethernet (registered trademark). The APC1 may be a master adaptive pressure controller connected with the main PC 100 via the sub PC 200d. The APC2, APC3 and APC4 may be slave adaptive pressure controllers connected with the master APC1 in series. Each of the APC1, APC2, APC3 and APC4 may be set to be “in an interlocked state” or “in a non-interlocked state” by an operator. A gate valve 370 may be an opening/closing port configured to load/unload the substrate G while maintaining airtightness in the processing chamber.

With this configuration, a control signal from the main PC 100 may be transmitted to each device via the sub PC 200d. By way of example, the microwave source 336, the high frequency power supply 314, a high voltage DC power supply 318, a valve or a mass flow controller (all not illustrated) of the gas supply, source 348, APC1, APC2, APC3, APC4, the dry pump (DRP) 356, the turbo molecular pump (TMP) 358, and the gate valve 370 may be controlled at a predetermined time in response to the control signal. As a result, while maintaining the inside of the processing chamber at a desired vacuum level, the gas supplied into the processing chamber may be excited into plasma by electric field energy of a microwave introduced into the processing chamber and a film forming process may be performed onto the substrate G by an action of the plasma.

[Sensor Group]

The process module PM3 may be provided with various sensors S1 to S5 as a sensor group PM3s configured to detect a status of each device within the process module PM3, and detection values (output signal) may be transmitted to the safety PLC 300d.

To be specific, the sensor S1 may be an on/off switch. The sensor S1 serving as the switch becomes an on state (switch on) by a pressure of the lid 302 when the lid 302 is closed, whereas the sensor 51 becomes an off state (switch off) by the cancellation of the pressure of the lid 302 when the lid 302 is opened. In this way, the sensor S1 may detect an opening/closing status of the ceiling of the processing chamber C and transmit a detection result to the safety PLC 300d.

The sensor S2 may be an opening degree detection sensor attached to the gate valve 370 and the sensor S2 may detect an opening/closing status of the gate valve 370 by detecting an opening degree of the gate valve 370 and transmit a detection result to the safety PLC 300d.

The sensor S3 may be an alarm device attached to the dry pump (DRP) 356 and the sensor S3 may detect an on/off status of a power supply of the DRP 356. If the DRP 356 is not controlled at a predetermined time (power off), the sensor S3 may output an alarm to the safety PLC 300d.

The sensor S4 may be an on/off switch like the sensor S1. The sensor S4 may detect whether or not the substrate G is mounted on a stage by turning on/off the switch depending on whether or not the substrate G exists and transmit a detection result to the safety PLC 300d.

The sensor S5 may be a vacuum gauge and may be installed to penetrate a sidewall of the processing chamber C while its external surface is fixed by a cover part T. The sensor S5 may measure a vacuum pressure within the processing space and transmit a measurement value to the safety PLC 300d.

[Internal Configuration of Process Module PM4]

Hereinafter, an internal configuration of the six-layer consecutive organic EL vapor deposition apparatus of the process module PM4 will be explained briefly with reference to FIG. 3. In the process module PM4, six layers including an organic EL layer may be deposited consecutively on the substrate G.

The process module PM4 may include six deposition sources 410a to 410f. The six deposition sources 410a to 410f may contain different kinds of film forming materials therein, and a crucible in each deposition source 410 may be heated to be in a range of, for example, from about 200° C. to about 500° C., so that the film forming material in the crucible may be vaporized.

The six deposition sources 410a to 410f may be connected to six discharging containers 430a to 430f via six connection pipes 420a to 420f. Each film forming material vaporized in the six deposition sources 410a to 410f may pass through the six connection pipes 420a to 420f, respectively and may be discharged through an opening OP (discharge opening) formed in an upper surface of each of the six discharging containers 430a to 430f.

Partition walls 440 may be disposed between the respective discharging containers 430, and the seven partition walls 440 may partition the discharging containers 430 so as to prevent mixing of gas molecules discharged from adjacent discharging containers 430.

The substrate G may be electrostatically attracted onto a stage including a sliding unit (all not illustrated) near a ceiling surface of the process module PM4 and may move slightly higher than the respective six discharging containers 430a to 430f from the first discharging container 430a to the sixth discharging container 430f in sequence. Thus, six different films of the film forming materials discharged from the discharging containers 430a to 430f may be consecutively formed on the substrate G.

Further, in the same manner as the process module PM2, the process module PM4 may include the sensor group PM4s configured to detect a status of each device in the process module PM4 and detection values of the sensor group PM4s may be transmitted to the safety PLC 300e. Details thereof will be omitted herein.

[Hardware Configuration of PC]

A hardware configuration of the main PC 100 will be explained in brief. Since a hardware configuration of the sub PC 200 is substantially the same as the main PC 100, only the main PC 100 will be explained herein. The main PC 100 may include non-illustrated ROM, RAM, CPU, bus and interface. The ROM may store a basic program to be executed in the main PC 100, a program to be started in an abnormal state, or various kinds of recipes. The RAM may store various kinds of data. The ROM and RAM are examples of a memory, and for example, an EEPROM, an optical disc, a magneto-optical disc may be used as a memory. The CPU may output a signal to control a substrate process according to various kinds of recipes (programs). The bus may be a path to receive/transmit data between the ROM, the RAM, the CPU and the interface.

[Function of Safety PLC]

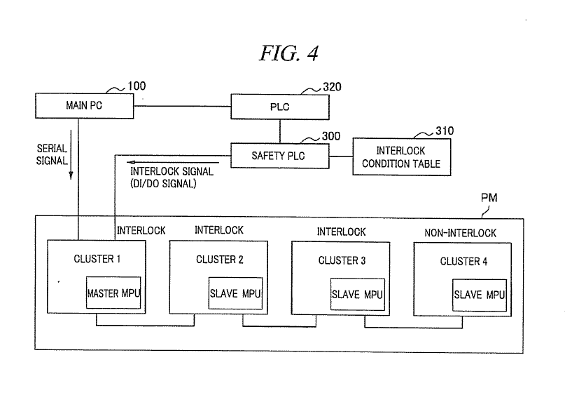

Hereinafter, a function of the safety PLC 300 will be explained with reference to FIG. 4. In the present embodiment, in addition to a hardware interlock device PLC 320, there may be installed a safety-certified safety PLC 300 implemented by programming an interlock function of the hardware (safety circuit) to control the interlock function.

The main PC 100 may output a serial signal as a control signal. A pulse signal as a DI (Digital Input)/DO (Digital Output) may be input/output to/from the safety PLC 300. If a predetermined interlock condition stored in an interlock condition table 310 is satisfied, the safety PLC 300 may output an interlock signal to notify abnormality.

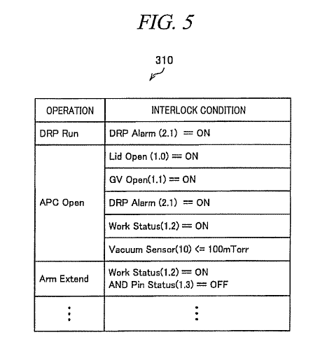

As depicted in FIG. 5, the interlock condition table 310 may store information on interlock conditions related to each device. In FIG. 5, the following five conditions may be set as an interlock condition of whether or not to stop an “opening” operation of an APC. By way of example, “Lid Open (1.0)==ON” may indicate that a 0^{th} bit of an address “1” at which a state of the lid 302 is stored is ON (i.e. open). In this case, the safety PLC 300 may output an interlock signal for indicating an abnormal state. Whether the lid 302 is “ON (open)” or “OFF (closed)” may be frequently updated based on an output signal from the sensor S1 of FIG. 2.

“GV Open (1.1)==ON” may indicate that a 1^{st} bit of the address “1” at which a state of the gate valve 370 is stored is ON (i.e. open). In this case, the safety PLC 300 may output an interlock signal for indicating an abnormal state. Whether the gate valve 370 is ON (open) or OFF (closed) may be frequently updated based on an output signal from the sensor S2 of FIG. 2.

“DRP Alarm (2.1)==ON” may indicate that a 1^{st} bit of an address “2” at which a state of an alarm device of the dry pump 356 is stored is ON (i.e. an alarm is generated). In this case, the safety PLC 300 may output an interlock signal for indicating an abnormal state. Whether the alarm device of the dry pump 356 is ON (alarm is generated) or OFF (alarm is not generated) may be frequently updated based on an output signal from the sensor S3 of FIG. 2.

“Work Status (1.2)==ON” may indicate that a 2^{nd} bit of the address “1” at which an electrostatically attracted state of the substrate G is stored is ON (neutralized, i.e. the substrate G is not electrostatically attracted). In this case, the safety PLC 300 may output an interlock signal for indicating an abnormal state. Whether the electrostatically attracted state of the substrate G is ON (neutralized) or OFF (the substrate G is electrostatically attracted) may be frequently updated based on an output signal from the sensor S4 of FIG. 2.

“Vacuum Sensor<=100 mTorr” may indicate that 16 bits of an address “10” at which a vacuum state in the processing chamber is stored is about 100 mTorr or less. In this case, the safety PLC 300 may output an interlock signal for indicating an abnormal state. Whether or not the vacuum state in the processing chamber is about 100 mTorr or less may be frequently updated based on an output signal from the sensor S5 of FIG. 2.

As explained above, if at least one of the predetermined interlock conditions is satisfied, the safety PLC 300 may output an interlock signal for indicating an abnormal state. If the predetermined interlock conditions are not satisfied, an interlock signal for indicating a normal state may be output.

[Interlock Control and Non-Interlock Control]

As depicted in FIG. 4, if a multiple number of devices (clusters 1 to 4) of the same kind are provided in the process module PM, the devices may be selected to be either an interlocked state or a non-interlocked state with other devices. In this case, a multiple number of devices selected to be in an interlocked state can perform interlocked operations in response to a control signal (cluster control). To be specific, the control signal may be transmitted from a master micro computer MPU (Micro Processing Unit) of the cluster 1 to a slave MPU of the cluster 2, and the control signal may be transmitted from slave MPU of the cluster 2 to a slave MPU of the cluster 3, so that the interlocked operations can be carried out. Meanwhile, other devices selected to be in a non-interlocked state may maintain the status quo. That is, the control signal may not be transmitted from the slave MPU of the cluster 3 to a slave MPU of a cluster 4 or even if the control signal is received, the interlocked operations may not be carried out. Consequently, the non-interlocked cluster 4 may maintain the status quo.

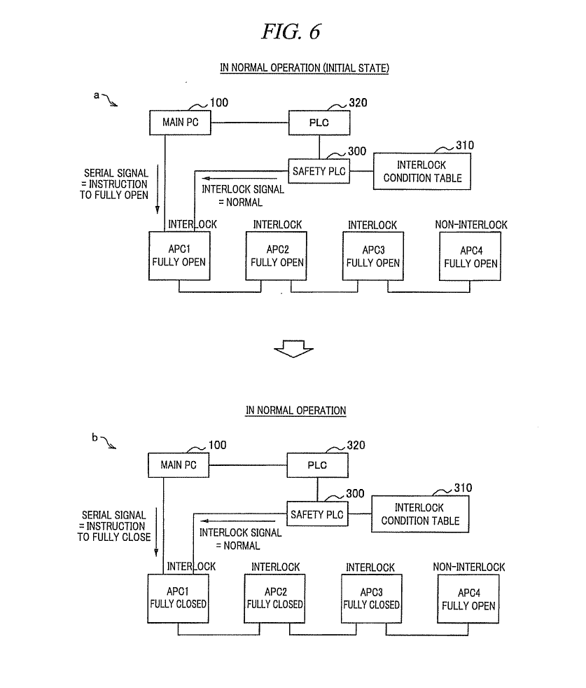

The multiple number of devices of the same kind (clusters 1 to 4) may include the APC1 to APC4 depicted in FIG. 2. By way of example, as depicted in FIG. 6(a), when an operation is performed in a normal state (for example, in an initial state), all the APC1 to APC4 are open. Further, an interlock signal to notify abnormality is not received from the safety PLC 300 (interlock signal=normal). Meanwhile, as depicted in FIG. 6(b), if a serial signal (control signal) to close the valves is received from the main PC 100, the MPUs of the APC1 to APC3 in the interlocked state may close the valves in response to the signal. However, the MPU of the APC4 in the non-interlocked state may not respond to the signal and maintain the valve as open. In this way, by setting the devices to be in the interlocked state or to be in the non-interlocked state, even if the multiple number of devices of the same kind are provided, the respective devices can perform a different operation each other. By way of example, an inside (APC4 side) of the process module PM3 may be sufficiently evacuated, whereas a foreside (APC1 to APC3 side) of the process module PM3 may not be evacuated.

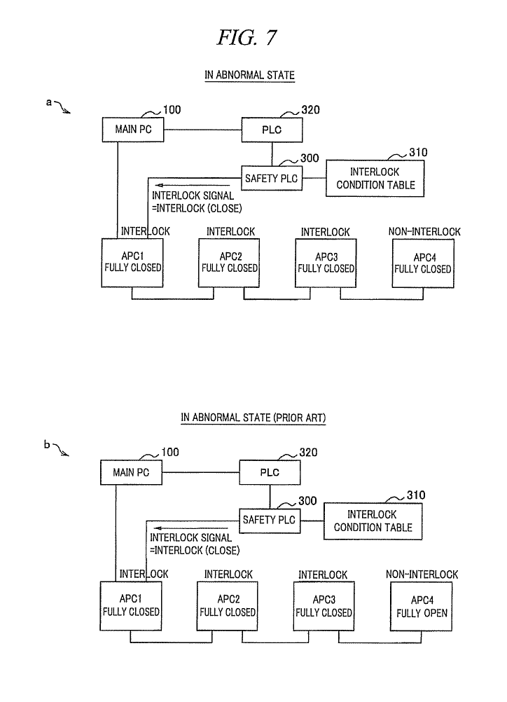

However, if the interlock/non-interlock functions respond to the control signal in a similar manner to the interlock signal, the following problem may arise. By way of example, if the lid 302 is open, the sensor S1 may detect it and the safety PLC 300 may determine that a predetermined interlock condition is satisfied and transmit an interlock signal to close the valves (FIG. 7(b): interlock signal=interlock (close)). If the interlock signal is received, the MPUs of the APC1 to APC3 in the interlocked state may control the valves to be closed in response to the interlock signal output from the safety PLC 300, whereas the MPU of the APC4 in the non-interlocked state may not respond to the interlock signal and may maintain the valve as open. Accordingly, even in case of emergency in need of avoidance of an accident in response to an instruction from the safety PLC 300, the non-interlocked device cannot be forced to be controlled in response to the interlock signal. If the interlock function is not imperfect, a safety action cannot be taken promptly, so that the system may be in an unsafe state. If the system is in a shutdown state or the system is operated in an unstable state, the inside of the processing chamber cannot be maintained in a desired atmosphere. Therefore, a processed substrate may not be valuable as a product and a throughput may become decreased and productivity of the system also may become decreased. Further, a system manager may feel pressured.

Therefore, in the present embodiment, as depicted in FIG. 7(a), if the safety PLC 300 transmits a signal to notify abnormality, the multiple number of devices of the same kind may be controlled in response to the interlock signal regardless of an interlocked state or a non-interlocked state of the devices. Accordingly, the non-interlocked APC4 is closed, and, thus, a safety action can be taken promptly in response to an instruction of the safety PLC 300 and the system can be operated in a stable state. Therefore, a throughput and productivity can be increased.

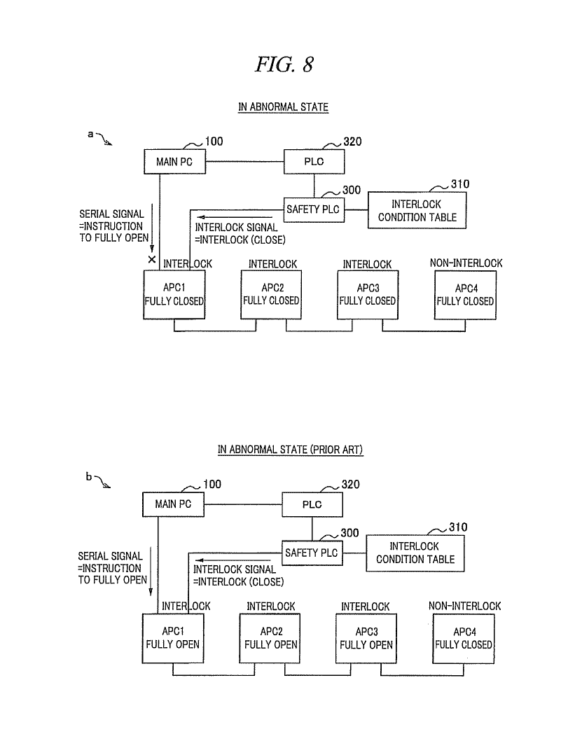

Conventionally, even while an interlock signal which satisfies a predetermined interlock condition is output (in an abnormal state), a multiple number of devices of the same kind have been controlled to be in an interlocked state in response to a control signal from a controller. By way of example, as depicted in FIG. 8(b), even while the safety PLC 300 transmits an interlock signal to close the valves in an abnormal state, if a serial signal (control signal) to open the valves is received from the main PC 100, the MPUs of the APC1 to APC3 in the interlocked state may control the valves to be open in response to the signal. Thus, even in case of an abnormal state, an instruction of the interlock signal may be overwritten with an instruction of the control signal and a part of the interlock signal may become invalid. Therefore, a safety of the system may not be sufficiently managed, so that the system can be in an unsafe state.

In the present embodiment, as depicted in FIG. 8(a), while an interlock signal which satisfies a predetermined interlock condition is received from the safety PLC 300, the MPUs of the APC1 to APC3 invalidate a control signal output from the main PC 100 and maintain operations according to an instruction of the interlock signal. Accordingly, the valves of the APC1 to APC3 can be maintained as closed while the interlock signal for indicating an abnormal state is output, and, thus, safety can be secured and the system can be operated stably. Therefore, a throughput and productivity can be increased.

The above-described functions of the APC1 to APC4 can be achieved by the MPU in each of the APC1 to APC4 by reading a required program from a storage area storing a program that describes a process sequence for implementing these functions and interpreting and executing the program.

[Operation of APC]

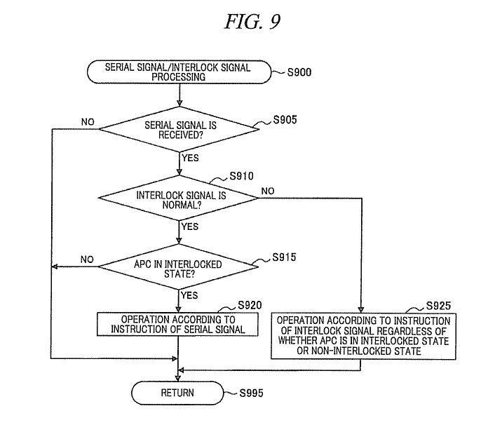

Hereinafter, an operation of the MPU of each of the APC1 to APC4 as the above-described multiple number of devices of the same kind will be explained with reference to a flowchart of FIG. 9. FIG. 9 is a flowchart of a serial signal/interlock signal process.

[Serial Signal/Interlock Signal Process]

The present process is started at every predetermined time period and started from step S900. The process proceeds to step S905, and the master MPU of the APC may determines whether or not a serial signal is received. If the serial signal is received, the MPU may proceed to step S910 and determine whether or not an interlock signal indicates normality. If the interlock signal indicates normality, processing may continue to step S915 and the MPU may determine whether or not the APC is selected to be in an interlocked state. If the APC is selected to be in the interlocked state, processing may continue to step S920 and the MPU may control according to an instruction of the serial signal. Then, processing may continue to step S995 and the present process may end.

Meanwhile, if the APC is selected to be in a non-interlocked state in step S915, processing may continue to step S995 immediately and the process may end. Accordingly, in a normal state, the APC in the interlocked state may perform an interlocked operation in response to the serial signal and the APC in the non-interlocked state may maintain the status quo regardless of the serial signal.

However, if the interlock signal indicates an interlock state (abnormality) in step S910, processing may continue to step S925 and the MPU of each APC may be forced to perform the interlocked operation according to an instruction of the interlock signal regardless of the interlocked state or the non-interlocked state of the APC1 to APC4, and thereafter, processing may continue to step S995 and the present process may end. In this way, in an abnormal state, regardless of the interlocked state or the non-interlocked state of the APC1 to APC4, a safety action may be a priority based on the interlock signal, and, thus, it may be possible to prevent an accident. Further, if the serial signal is not received in step S905, processing may continue to step S995 without doing anything and the present process may end immediately.

[Maintenance Screen]

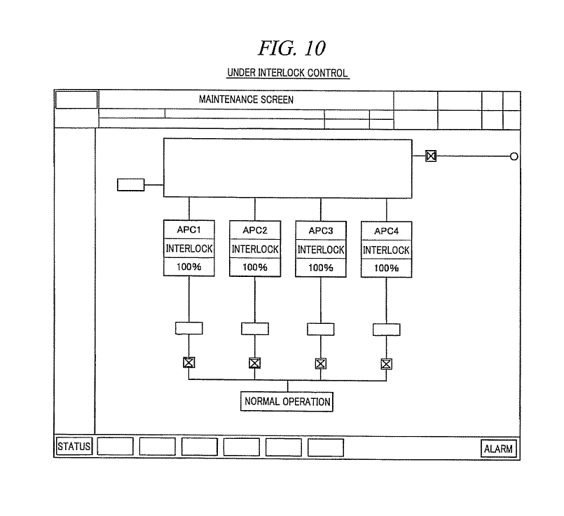

By way of example, on a display (corresponding to a display unit) of the main PC 100 or the sub PC 200 of FIG. 1, a maintenance screen depicted in FIGS. 10 to 12 may be displayed. FIG. 10 shows a maintenance screen when an interlocked operation is performed in a normal state. In FIG. 10, all the APC1 to APC4 are interlocked and an opening degree of each valve is about 100%. If it is determined that all the APCs are interlocked in step S915, the maintenance screen may display a case in which all the APCs are entirely open (100% open) according to an instruction of a serial signal in step S920.

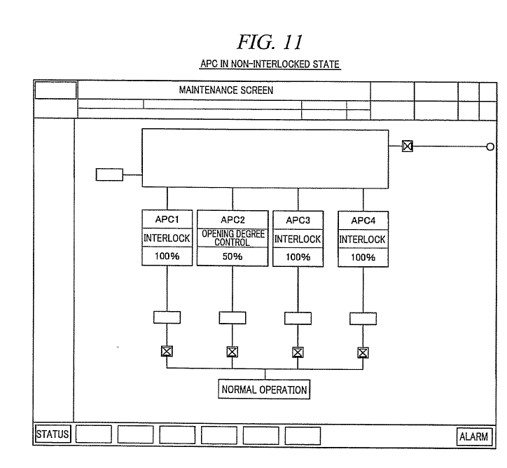

FIG. 11 depicts a maintenance screen showing a case in which the APC1, APC3 and APC4 are in an interlocked state and the APC2 is in a non-interlocked state. In FIG. 11, an opening degree of each of the APC1, APC3 and APC4 is about 100%, whereas an opening degree of the APC2 is about 50%. Thus, it can be seen that an operation of the APC2 may be not interlocked with operations of the other APCs. If it is determined that the APC1, APC3 and APC4 are in the interlocked state in step S915, the maintenance screen may display a case in which the APC1, APC3 and APC4 are entirely open (100% open) according to an instruction of a serial signal in step S920. In this case, the maintenance screen may display a case in which the APC2 maintains the status quo (50% open).

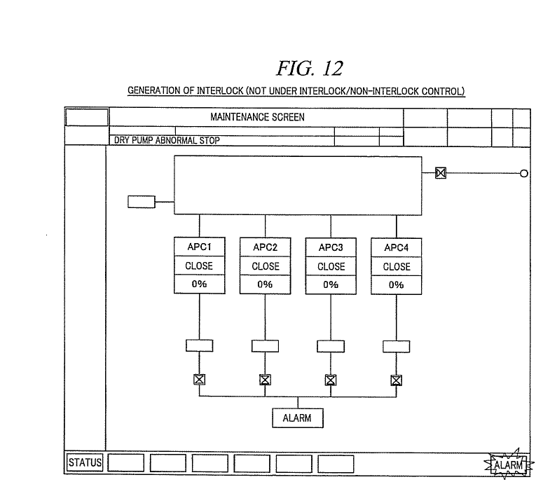

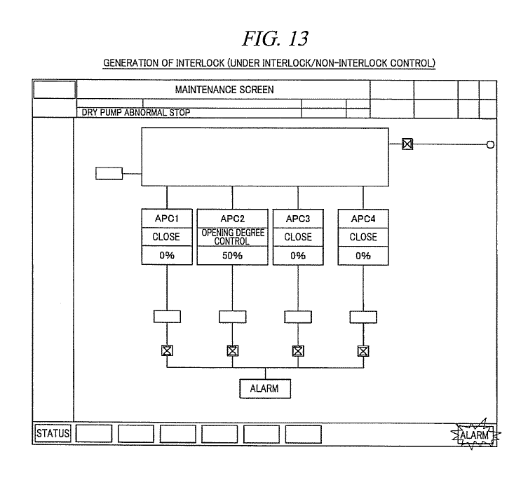

FIG. 12 depicts a maintenance screen showing a case in which an interlock signal for indicating an interlocked state (close state). Conventionally, even in case of an interlocked state (abnormal state), a control has been performed with consideration of an interlocked state and a non-interlocked state. For this reason, as depicted in FIG. 13, if an interlock signal indicates an interlocked state (close state), conventionally, a maintenance screen has displayed that the APC2 in a non-interlocked state does not respond to an instruction of the interlock signal and maintains the status quo (50% open) in spite of the abnormal state.

However, FIG. 12 shows that an opening degree of each of the APC1 to APC4 is about 0%. If it is determined that an interlock signal does not indicate a normal state in step S910, the maintenance screen may display that all the APC1 to APC4 are entirely closed according to an instruction of the interlock signal regardless of an interlocked state or a non-interlocked state of the APC1 to APC4 in step S925. Further, “alarm” sign may be displayed to warn an operator about the abnormal state.

As described above, the maintenance screen in accordance with the present embodiment may display a status in which devices in a non-interlocked state among a multiple number of devices of the same kind are interlocked with other devices in an interlocked state, while an interlock signal that satisfied a predetermined interlock condition is output. Thus, it can be seen that all cluster devices are interlock-controlled under a control of the safety PLC 300.

[Cancellation Process]

Hereinafter, there will be explained a cancellation process after an abnormal state is resolved. If an interlock signal that satisfies a predetermined interlock condition is cancelled (interlock signal=normal), MPCs of the APC1 to APC4 may validate a serial signal output from the main PC 100 and only the APC selected to be in an interlocked state may be interlocked according to an instruction of the serial signal. This can be achieved by executing steps S915 and S920 of FIG. 9. Consequently, the maintenance screen may display an interlocked state or a non-interlocked state during a normal operation as depicted in FIG. 10 or FIG. 11.

As described above, in accordance with the present embodiment, if sensors attached to a multiple number of devices of the same kind detect abnormality and it is determined that any one of the devices of the same kind satisfies a predetermined interlock condition, an interlock signal to notify abnormality may be output. The multiple number of devices of the same kind may be interlocked according to an instruction of the interlock signal regardless of an interlocked state or a non-interlocked state of the devices. Thus, even if there is a non-interlocked device, all the multiple number of devices of the same kind may be forced to perform operations according to the instruction of the interlock signal. Consequently, all the devices can perform an interlock function and a safety action can be taken promptly. Thus, it may be possible to avoid a shutdown of a system, so that a throughput can be improved. Further, a maintenance burden on a system manager may be reduced.

In accordance with the present embodiment, all cluster devices may not be connected to the safety PLC 300 through cables. That is, in the present embodiment, a signal processing may be performed just by changing software (program) in the present hardware configuration of the substrate processing system without changing the present arrangement of the devices or the present connection status between the devices. Thus, it may be easy to apply the software to the present system and it may be not necessary to change cables. Therefore, it may be possible to reduce the cables to be used.

### Second Embodiment

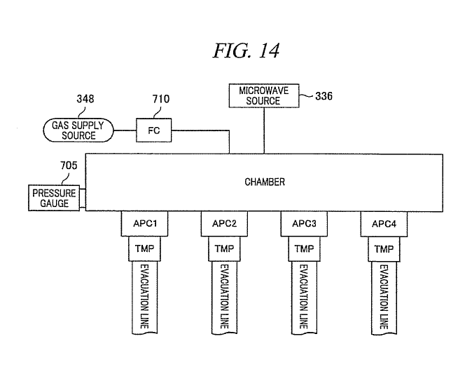

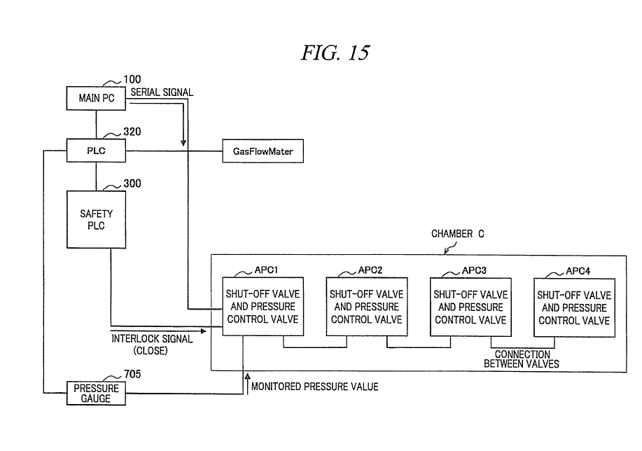

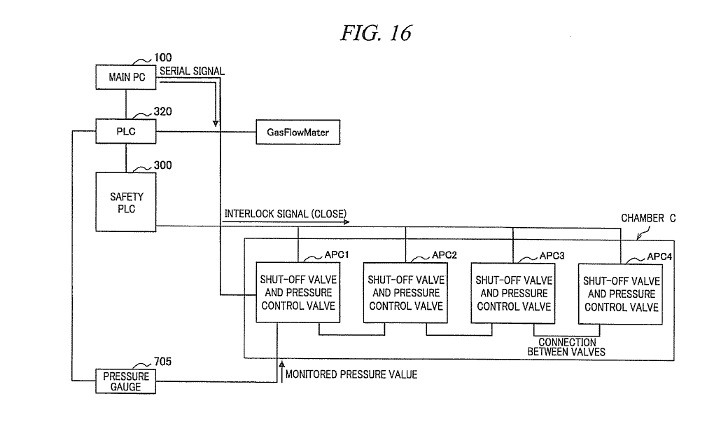

In the first embodiment, there has been explained an interlock control when an APC valve is used as an evacuation device. The APC valve may be a pressure control valve having a function of a shut-off valve and the APC valve may include the shut-off valve and the pressure control valve as a single part. FIG. 14 is a schematic diagram of a process module when a shut-off valve and a pressure control valve are provided as a single part (in case of an APC valve). FIG. 15 shows an example of an interlock signal input when a shut-off valve and a pressure control valve are provided as a single part (in case of an APC valve). FIG. 16 shows another example of an interlock signal input when a shut-off valve and a pressure control valve are provided as a single part (in case of an APC valve).

As depicted in FIG. 14, a pressure gauge 705 may detect an internal pressure of the chamber frequently and output a monitored pressure value. The chamber C (processing chamber) may control an opening degree of an APC valve such that the internal pressure is set to a target pressure value based on a gas flow rate controlled by a flow controller 710. In this way, the internal pressure of the chamber C can be controlled.

If an interlock generating condition is satisfied, an interlock signal (close) line may be connected to each of the APC valves in series as depicted in FIG. 15 or may be connected to each of the APC valves as depicted in FIG. 16.

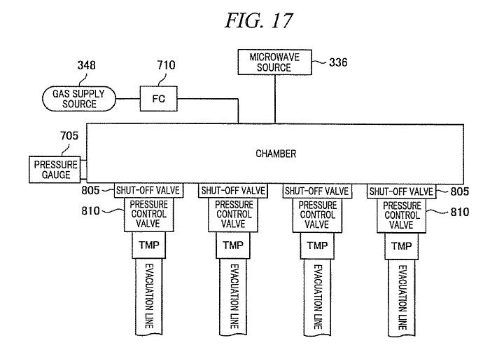

Meanwhile, an evacuation device in accordance with the second embodiment may include a shut-off valve 805 and a pressure control valve 810 provided independently from each other, as depicted in FIG. 17. FIG. 17 is a schematic diagram of a process module when a shut-off valve and a pressure control valve are provided independently from each other.

As described above, in the second embodiment, the valve may include the shut-off valve 805 and the pressure control valve 810 and may be positioned on an evacuation side of the substrate processing apparatus. Further, each valve may be arranged in parallel with each other. The pressure control valves 810 may be controlled in an interlocked mode and a non-interlocked mode with respect to the shut-off valves 805. If it is determined that a predetermined interlock condition is satisfied, the pressure control valves 810 may be interlocked according to an instruction of an interlock signal regardless of an interlocked state or a non-interlocked state of the pressure control valves.

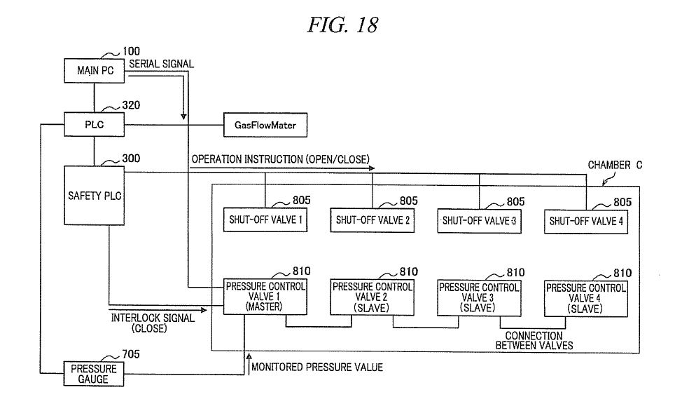

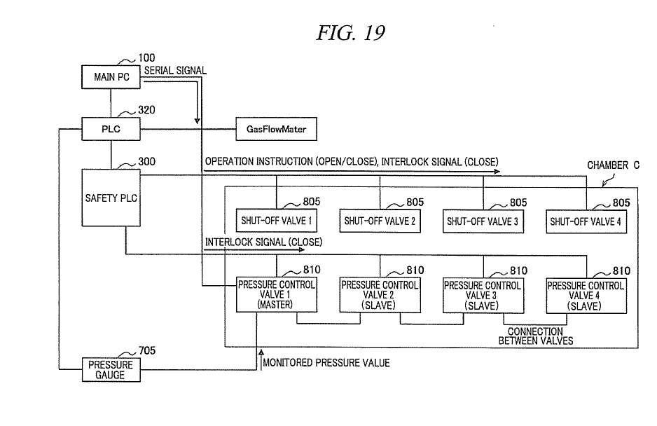

FIG. 18 shows an example of a signal input when the shut-off valve 805 and the pressure control valve 810 are provided independently from each other. The pressure gauge 705 may frequently detect an internal pressure of a chamber and output a monitored pressure value. In the second embodiment, a pressure control (adjustment of an opening degree by a pressure control valve 1) may be carried out such that the internal pressure of the chamber C is set to a target pressure value based on the monitored pressure value. In this case, a master pressure control valve 1 depicted in FIGS. 18 and 19 may determine an adjustment value of a pressure. Slave pressure control valves 2, 3 and 4 may adjust an opening degree of each of the pressure control valves 2, 3 and 4 to be an opening degree instructed from the pressure control valve 1. In this way, by controlling the pressure control valves 2, 3 and 4 to follow the pressure control valve 1, oscillation of the pressures can be prevented without a difference in opening degree or control between the valves. Thus, it may be possible to stably control an internal pressure of the chamber C as a desired level.

FIG. 18 shows an example of a signal input when the shut-off valve 805 and the pressure control valve 810 are provided independently from each other. In this case, a serial signal and a monitored pressure value may be transmitted to the pressure control valve 1. A safety PLC may transmit an operation instruction signal for an opening operation or a closing operation to shut-off valves 1 to 4. Each of the shut-off valves 1 to 4 may be opened or closed in response to the operation instruction signal.

If the interlock generating condition is satisfied, an interlock signal for a closing operation may be transmitted to a pressure control valve. In FIG. 18, the interlock signal may be input to the master pressure control valve 1. In this case, the master pressure control valve 1 may be closed in response to the interlock signal and the interlock signal may be transmitted to the slave pressure control valves 2 to 4 so as to be closed.

FIG. 19 shows another example of signal input when the shut-off valve 805 and the pressure control valve 810 are provided independently from each other. In this case, a serial signal and a monitored pressure value may be transmitted to the pressure control valve 1. Meanwhile, an operation instruction signal may be transmitted to all shut-off valves 1 to 4. Further, an interlock signal may be transmitted to the respective pressure control valves 1 to 4 so as to be closed. The interlock signal may also be transmitted to the respective shut-off valves 1 to 4 so as to be closed.

If the interlock generating condition is satisfied, all the shut-off valves 1 to 4 and pressure control valves 1 to 4 are required to be closed in consideration of the following operations of the shut-off valves 1 to 4 and pressure control valves 1 to 4. However, at the time of generation of interlock, a safety action of closing the shut-off valves 1 to 4 may be taken or a safety action of closing the pressure control valves 1 to 4 may be taken.

The pressure control valves 810 may be functioned in four different patterns: 1) the pressure control valves 810 may not be operated in a fully closed state (non-interlocked state); 2) the pressure control valves 810 may not be operated in a fully open state (non-interlocked state); 3) the pressure control valves 810 may be locked at a certain opening degree by controlling an opening degree (non-interlocked state); and 4) the pressure control valves 810 may be opened and closed automatically such that a pressure can be maintained at a certain value by controlling a pressure according to a pressure gauge (interlocked state). Upon generating an interlock, all the pressure control valves 1 to 4 may be closed in response to an interlock signal regardless of whether the pressure control valves 1 to 4 are in an interlocked state or non-interlocked state.

The pressure control valves 810 having the four different patterns may be operated in various combinations of the patterns. By way of example, some of the pressure control valves may be fully opened and the other valves may control a pressure. Further, some of the pressure control valves may control an opening degree and the other valves may control a pressure. Furthermore, some of the pressure control valves may be fully closed and the other valves may control a pressure. Herein, in case of partially full close, the valves may not be completely closed and an opening degree may be controlled to be about 1%, so that it may possible to prevent stay of dust or adhesion to a sealing member.

As a size of the chamber is increased, a multiple number of shut-off valves and pressure control valves may be needed. Therefore, an atmosphere within the chamber can be accurately controlled by determining which valves are used or not in detail.

(In Case of Large Flow Rate)

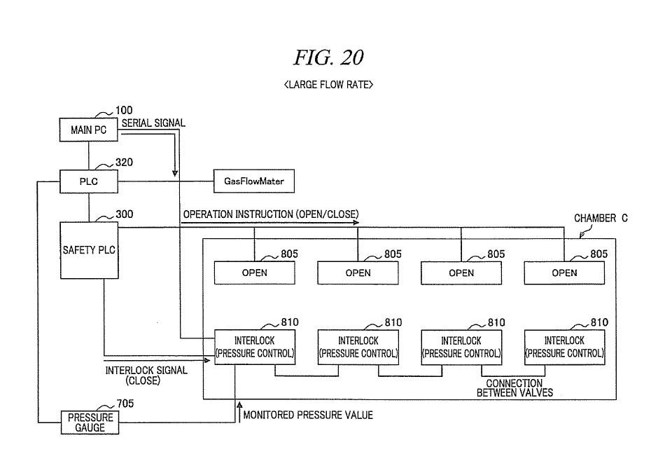

FIG. 20 shows an operation example in case of, for example, a large flow rate. In case of the large flow rate, a pressure may be controlled by using all the shut-off valves 805 and pressure control valves 810. That is, in case of the large flow rate, all the shut-off valves 805 may be opened and the pressure control valves 810 may control a pressure by controlling an opening degree of the all the pressure control valves 810 such that an internal pressure of the chamber can be a target pressure value based on a monitored pressure value of the pressure gauge 705.

If the interlock generating condition is satisfied, an interlock signal for a closing operation may be input to the master pressure control valve 810, so that the master pressure control valve 810 may be fully closed. The master pressure control valve 810 may transmit a signal for a fully closing operation to the three slave pressure control valves 810, so that the three slave pressure control valves 810 in an interlocked state may be fully closed. Furthermore, an operation instruction signal for a closing operation may be input to all the shut-off valves 805, so that all the shut-off valves 805 may be closed. Thus, in case of the large flow rate, in a normal state, all the shut-off valves 805 and pressure control valves 810 may be opened and a pressure of the chamber may be controlled, whereas if the interlock generating condition is satisfied, all the shut-off valves 805 and pressure control valves 810 may be fully closed and the operations of the valves may be forced to end. Further, in case of generation of interlock, if an interlock signal may be input not to the shut-off valves 805 but to the pressure control valves 810, the shut-off valves 805 may be maintained as open.

(In Case of a Middle Flow Rate)

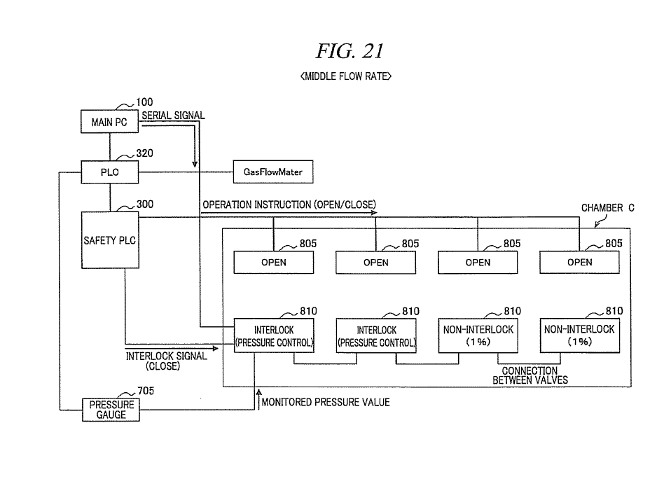

In an operation example in case of a middle flow rate, as depicted in FIG. 21, some of the pressure control valves 810 may be interlocked to control a pressure and the other pressure control valves 810 may be non-interlocked (for example, an opening degree of about 1%). At the time of a normal operation, all the shut-off valves 805 may be opened in response to an operation instruction signal.

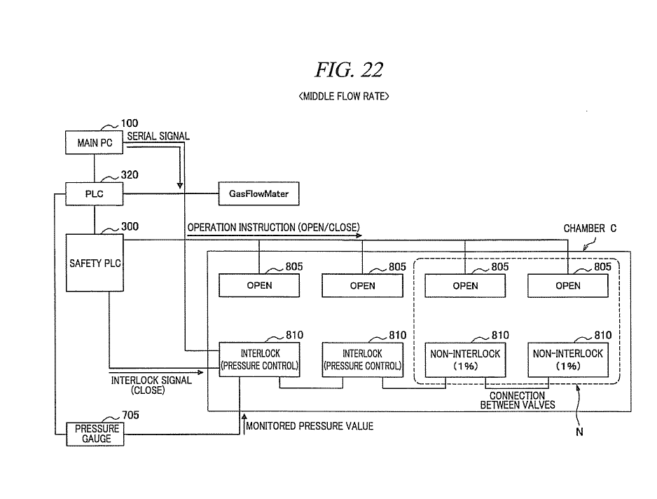

In this case, the pressure control valves 810 included in a dashed line area N of FIG. 22 may not be interlocked with the other pressure control valves 810. However, if the interlock generating condition is satisfied, a safety action (closing operation) may need to be taken to the pressure control valves 810 included in the dashed line area N so as to be interlocked with the other pressure control valves 810.

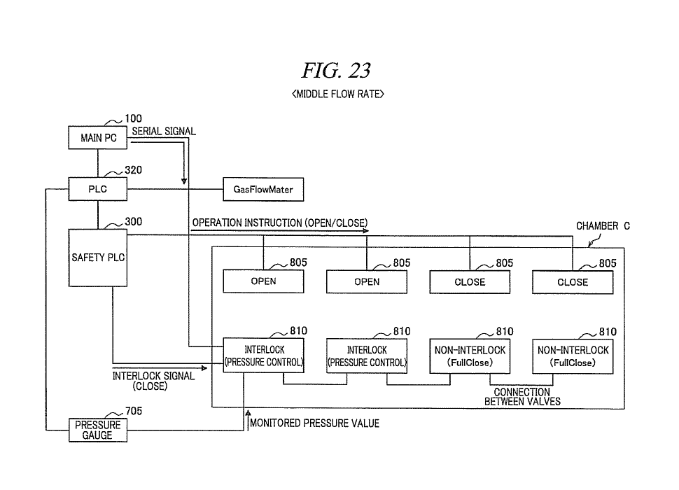

Therefore, if the interlock generating condition is satisfied, as depicted in FIG. 23, two pressure control valves 810 under pressure control may be fully closed in response to an interlock signal for a closing operation and two non-interlocked pressure control valves 810 (an opening degree of about 1%) may be forced to be fully closed according to an instruction of the master pressure control valve 810 and the operations of the non-interlocked pressure control valves 810 may be forced to end.

Otherwise, if the interlock generating condition is satisfied, the interlock signal for a closing operation (operation instruction signal) may be transmitted to all the shut-off valves 805 but not to the pressure control valves 810 so as to close all the shut-off valves 805. However, in consideration of the following operation or a safety issue, as described above, the pressure control valves 810 are required to be fully closed and all the shut-off valves 805 are required to be closed, and at least the pressure control valves 810 are required to be fully closed.

(In Case of a Small Flow Rate)

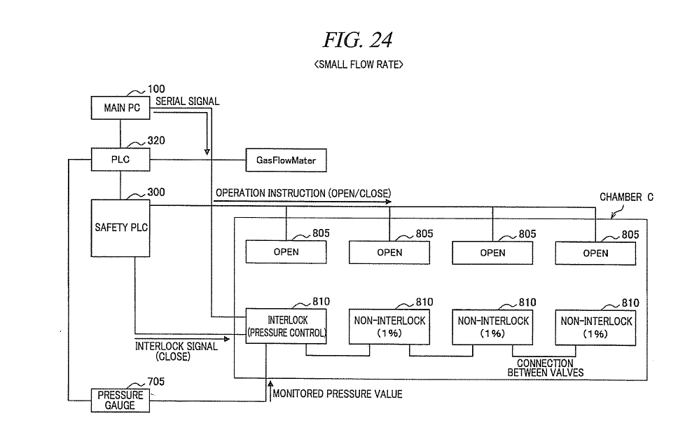

In an operation example in case of a small flow rate, as depicted in FIG. 24, one of the pressure control valves 810 may be interlocked to control a pressure and the other three pressure control valves 810 may be non-interlocked (for example, an opening degree of about 1%). At the time of a normal operation, the shut-off valves 805 may be opened in response to an operation instruction signal.

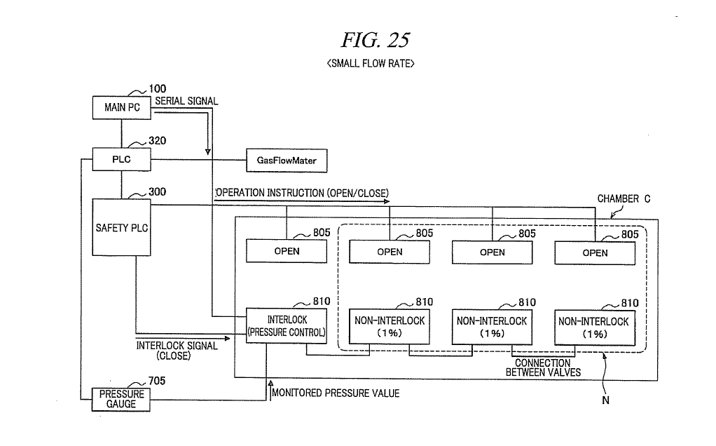

In this case, the pressure control valves 810 included in a dashed line area N of FIG. 25 may not be interlocked with the other pressure control valve 810. However, in case of the small flow rate, if the interlock generating condition is satisfied, a safety action (closing operation) may need to be taken to the pressure control valves 810 included in the dashed line area N.

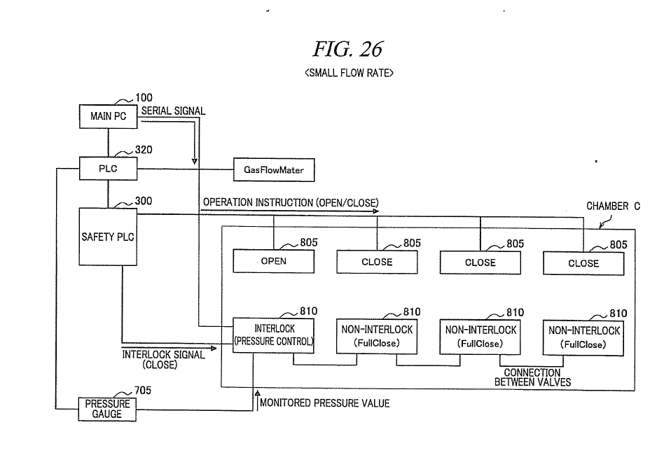

Therefore, if the interlock generating condition is satisfied, as depicted in FIG. 26, the master pressure control valve 810 under pressure control may be fully closed in response to an interlock signal for a closing operation and three non-interlocked pressure control valves 810 (an opening degree of about 1%) may be forced to be fully closed according to an instruction of the master pressure control valve 810 and the operations of the non-interlocked pressure control valves 810 may be forced to end.

There has been explained a safety action taken when the shut-off valve 805 and the pressure control valve 810 are provided independently from each other in accordance with the second embodiment. In accordance with the above explanation, even if there may be a difference in an operation condition of the pressure control valves 810 in each case of the large flow rate, the middle flow rate and the small flow rate, if the interlock generating condition is satisfied, the safety action (closing operation) can be taken to all the pressure control valves 810.

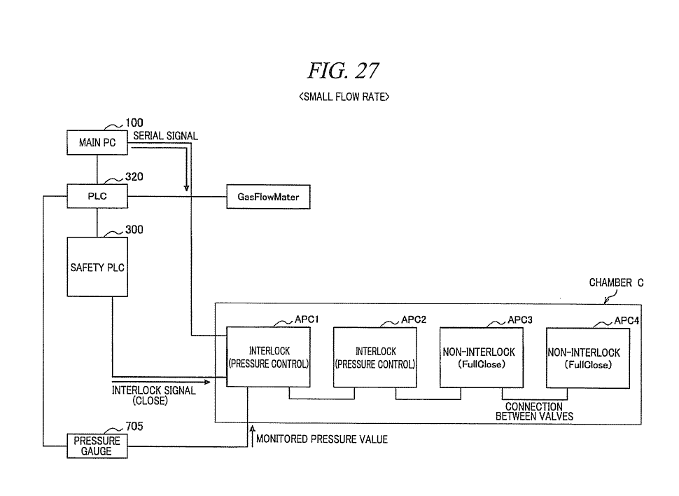

The safety action of the integrated valves (APC valves) in each case of the large flow rate, the middle flow rate and the small flow rate may be basically the same as the safety action of the valves provided independently from each other. By way of example, as for the APC valves, in case of the small flow rate, an APC1 and an APC2 may be interlocked to control a pressure and an APC3 and an APC4 may be non-interlocked, for example, a fully closed state as depicted in FIG. 27.

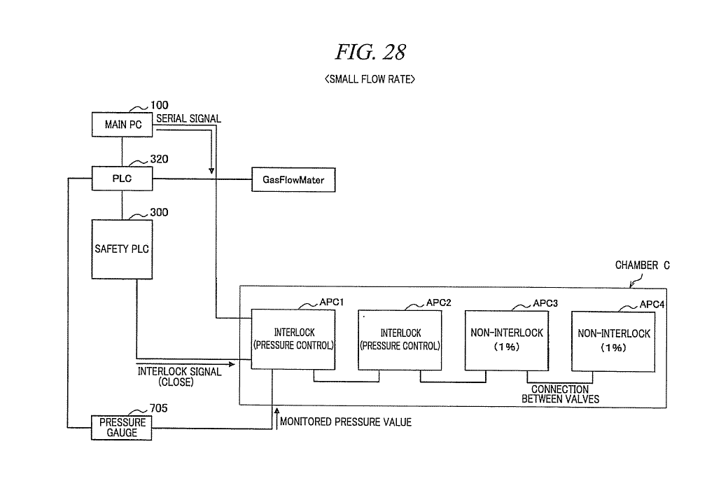

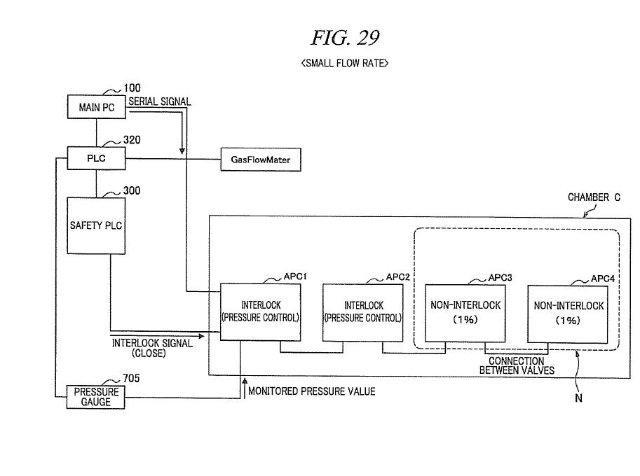

In case of the small flow rate, as depicted in FIG. 28, an APC1 and an APC2 may be interlocked to control a pressure and the other valves may be non-interlocked (for example, an opening degree of about 1%). In this case, an APC3 and an APC4 included in a dashed line area N of FIG. 29 may not be interlocked with the APC1 and APC2. However, if the interlock generating condition is satisfied, a safety action (closing operation) may need to be taken to the APC valves included in the dashed line area N.

Thus, if the interlock generating condition is satisfied, the interlocked APC1 and APC2 may be fully closed in response to an interlock signal for a closing operation and the non-interlocked APC3 and APC4 may also be fully closed and the operations of the APC3 and APC4 may be forced to end.

In the system in accordance with each embodiment, if a software interlock component (device) transmits a signal to notify abnormality, a multiple number of devices of the same kind can be controlled in response to an interlock signal regardless of an interlocked state or a non-interlocked state of the devices. Accordingly, a safety action can be taken appropriately.

The APC valve in accordance with the first embodiment and the valve including the shut-off valve and the pressure control valve provided independently from each other in accordance with the second embodiment are examples of a valve having a shut-off function in the substrate processing apparatus. A plural number of the above-described valves may be provided in the substrate processing apparatus, and in this case, the valves may be arranged in parallel with each other. Further, the valves may be provided on an evacuation side of the substrate processing apparatus.

In the same manner as the first embodiment, in the second embodiment, during a generation of an interlock signal, an instruction through a serial communication may be ignored regardless of the master device or the slave device or in the interlocked state or the non-interlocked state, and, thus, a normal operation may not be carried out until a problem of the system is solved.

In the above-described embodiments, an operation of each device may be correlated with each other and can be substituted with a series of steps in consideration of correlation therebetween, and, thus, an embodiment of the substrate processing apparatus may be modified to an embodiment of a substrate processing method using the substrate processing apparatus. Further, by substituting the operation of the substrate processing system with steps for implementing a function of the substrate processing system, an embodiment of the substrate processing system may be modified to an embodiment of a storage medium storing a program for implementing a function of the substrate processing system on a computer. Furthermore, the program for implementing a function of the substrate processing system on a computer may be stored in the storage medium or may be transmitted via a network or the like.

The embodiments of the present invention have been explained with reference to the accompanying drawings but the present invention is not limited to the above-described embodiments. It would be understood by those skilled in the art that various changes and modifications may be made within a scope of the claims and their equivalents are included in the scope of the present invention.

By way of example, the multiple number of devices of the same kind in the substrate processing apparatus in accordance with the present invention may not be limited to the APC valves. Any device is possible as long as a multiple number of cluster devices of the same kind can be selected to be interlocked or non-interlocked with other device.

The plasma processing apparatus in accordance with the present invention may process a large-sized glass substrate, a circular silicon wafer or a rectangular SOI (Silicon On Insulator) substrate.

The substrate processing apparatus in accordance with the present invention may include an etching apparatus, a CVD apparatus, a coater developer, a cleaning apparatus, a CMP (Chemical Mechanical Polishing) apparatus, a PVD (Physical Vapor Deposition) apparatus, an exposure apparatus, an ion implanter, and the like.

In the above-described embodiments, although there has been explained each case of a large flow rate, a middle flow rate and a small flow rate using four APC valves or four shut-off valves and four pressure control valves for convenience sake, the number of the APC valves, the number of the shut-off valves, and the number of the pressure control valves are not limited to four and can be determined appropriately depending on a size of the chamber. The above-described method of controlling the pressure control valves is provided as an example, and a position of the pressure control valves and the controlling method can be changed depending on a size of the chamber.

The substrate processing system in accordance with the present invention can be applied to a semiconductor manufacturing apparatus, a FPD (Flat Panel Display), a solar cell manufacturing apparatus, an organic EL device or the like.

### EXPLANATION OF CODES

10: Substrate processing system
100: Main PC
200: Sub PC
300: Safety PLC
302: Lid
310: Interlock condition table
354: APC valve
356: Dry pump DRP
358: Turbo molecular pump TMP
370: Gate valve
400: Network
500: LAN
600: Host computer
705: Pressure gauge
710: Flow controller
805: Shut-off valve
810: Pressure control valve

1. A substrate processing system comprising:
a controller that outputs a control signal for controlling a substrate processing apparatus; and
a software interlock component that outputs an interlock signal if a predetermined interlock condition is satisfied,
wherein in the substrate processing apparatus, a multiple number of devices of the same kind are provided and each device is selected to be either an interlocked state or a non-interlocked state with other devices,
the software interlock component is configured to output an interlock signal to any one of the multiple number of devices of the same kind if it is determined that the multiple number of devices of the same kind satisfy the predetermined interlock condition, and
if any one of the multiple number of devices of the same kind receives the interlock signal, the multiple number of devices of the same kind are interlocked according to an instruction of the interlock signal regardless of an interlocked state or a non-interlocked state of the devices.

2. The substrate processing system of claim 1,
wherein while the interlock signal that satisfies the predetermined interlock condition is output, the multiple number of devices of the same kind invalidate the control signal output from the controller and maintain interlocked operations according to the instruction of the interlock signal.

3. The substrate processing system of claim 1, further comprising:
a display that displays a status in which the devices in the non-interlocked state among the multiple number of devices of the same kind perform interlocked operations with the devices in the interlocked state while the interlock signal that satisfies the predetermined interlock condition is output.

4. The substrate processing system of claim 1,
wherein if the interlock signal that satisfies the predetermined interlock condition is cancelled, the multiple number of devices of the same kind validate the control signal output from the controller and the devices in the interlocked state perform interlocked operations according to an instruction of the control signal.

5. The substrate processing system of claim 3,
wherein the display displays whether the multiple number of devices of the same kind are in an interlocked state or a non-interlocked state if the interlock signal that satisfies the predetermined interlock condition is cancelled.

6. The substrate processing system of claim 1,
wherein the multiple number of devices of the same kind are a multiple number of automatic pressure controllers provided in the substrate processing apparatus.

7. The substrate processing system of claim 1,
wherein the multiple number of devices of the same kind are shut-off valves and pressure control valves provided independently from each other in the substrate processing apparatus, and
at least one of the shut-off valves and the pressure control valves performs an interlocked operation according to the instruction of the interlock signal if it is determined that the predetermined interlock condition is satisfied regardless of an interlocked state or a non-interlocked state of the valves.

8. A substrate processing method using a substrate processing system including a controller that outputs a control signal for controlling a substrate processing apparatus; and a software interlock component that outputs an interlock signal if a predetermined interlock condition is satisfied, the method comprising:
selecting each device, among a multiple number of devices of the same kind provided in the substrate processing apparatus, to be either an interlocked state or a non-interlocked state with other devices;
outputting, by the software interlock component, an interlock signal if the software interlock component determines that the multiple number of devices of the same kind satisfy the predetermined interlock condition; and
if any one of the multiple number of devices of the same kind receives the interlock signal, controlling the multiple number of devices of the same kind to be interlocked according to an instruction of the interlock signal regardless of an interlocked state or a non-interlocked state of the devices.

9. A storage medium having stored thereon a computer-executable program for implementing, a function of a substrate processing system including a controller that outputs a control signal for controlling a substrate processing apparatus; and a software interlock component that outputs an interlock signal if a predetermined interlock condition is satisfied,
wherein the program causes a computer to perform operations comprising:
selecting each device, among a multiple number of devices of the same kind provided in the substrate processing apparatus, to be either an interlocked state or a non-interlocked state with other devices;
outputting, by the software interlock component, an interlock signal if the software interlock component determines that the multiple number of devices of the same kind satisfy the predetermined interlock condition; and
if any one of the multiple number of devices of the same kind receives the interlock signal, controlling the multiple number of devices of the same kind to be interlocked according to an instruction of the interlock signal regardless of an interlocked state or a non-interlocked state of the devices.

10. At least one valve having a shut-off function and provided in a substrate processing apparatus,
wherein each valve is configured to have an interlocked mode or a non-interlocked mode and each valve is interlocked according to an instruction of the interlock signal regardless of an interlocked state or a non-interlocked state of the valve if it is determined that a predetermined interlock condition is satisfied.

11. The at least one valve of claim 10,
wherein the at least one valve is plural in number and provided in the substrate processing apparatus.

12. The at least one valve of claim 11,
wherein the valves are arranged in parallel with each other.

13. The at least one valve of claim 10,
wherein the valve is positioned on an evacuation side of the substrate processing apparatus.
